(19) United States
(12) Patent Application Publication
(10) Pub. No.: US 2002/0080937 A1
(43) Pub. Date: Jun. 27, 2002

(54) Information processing apparatus and electronic appliance controlling system

(75) Inventor: Masakazu Kawamura, Tokyo (JP)

Correspondence Address: Paul J. Esatto, Jr., Scully, Scott, Murphy & Presser, 400 Garden City Plaza, Garden City, NY, 11530, US

(73) Assignee: NEC Corporation, Tokyo (JP)

(21) Appl. No.: 10/015,060

(22) Filed: Dec. 11, 2001

(30) Foreign Application Priority Data
Dec. 27, 2000 (JP) 2000-396351

(51) Int. Cl. H04M 11/00

(52) U.S. Cl. 379/102.03; 379/102.05

(57) ABSTRACT

A portable telephone 14 is connected to wire network 11 via a base station 13. To wire network 11 information server 12 for providing various information such as telecast programs and so on is connected. For example, data showing telecast programs are downloaded to portable telephone 14, and the G-code of any telecast program desired to record is extracted and transmitted to video tape recorder 17₁. There is no need to limit to a case wherein controlling information is transmitted in response to a request from the side of portable telephone 14 to various kinds of information servers 12, and it is possible for the side of information server 12 to appropriately supply the portable telephone with controlling information when any change is made to the controlling information to thereby control a relevant electronic appliance.

### BACKGROUND OF THE INVENTION

1. Field of the Invention

The present invention relates to an information processing apparatus such as a portable telephone, which is capable of acquiring necessary information from a communication network, and an electronic appliance controlling system, which controls external electronic appliances by using such information processing apparatus.

2. Description of the Related Art

Diverse kind of information processing apparatus, e.g., a portable telephone, which is capable of acquiring necessary information from a communication network, have been brought into existence and have come into wide use. Such information processing apparatus can be a personal handyphone system, various kind of handheld devices, and a portable type personal computer, other than the above-mentioned portable telephone. Many of these information processing apparatuses are provided with a function to acquire, via wire or radio, various kind of data from communication networks represented by the Internet.

Thus, there have been tried to operate external electronic appliances typically represented by household appliances, by using the data downloaded by the information processing apparatus from, for example, the Internet. For instance, data of the television programs is downloaded by a portable telephone from the Internet to see them when reservation of picture recording of a selected program or programs on a video tape recorder is made by using the accessory remote control device (it will hereinafter be referred to as “a remocon” for short.). Usual remocons can function to input actual telecasting date and time and television channels of a telecasting station or stations, and also can function to simplify the inputting operation for the picture recording by inputting a row of codes called “G-codes”.

Further, Registered Utility Model No. 3006697 has proposed a codeless telephone incorporating therein a function to make reservation by the use of G-codes. In this proposal, the G-codes function is accommodated in the conventional codeless telephone, and thus when a button of this telephone for the G-codes function is firstly pressed and a transmitting button is subsequently pressed, the G-codes can be transmitted from the telephone to a video recorder in order to make reservation for the picture recording. This telephone with the G-codes function also makes it possible to telephone at a place out of home in order to input the G-codes, so that the G-codes are transmitted to the video recorder in the home for making reservation for the picture recording.

Also, Japanese Publication of Unexamined Patent Applications No. 5-130181 published before the filing date of Japanese Utility Model No. 3006697 has proposed a mobile telephone provided with an infrared-ray remocon function capable of operating electronic appliances such as an air conditioner. This mobile telephone is also able to control the operation of the electronic appliances from a place out of home.

Further, Japanese Publication of Unexamined Patent Application No. 5-153270 published before the filing date of Japanese Utility Model No. 3006697 has proposed a codeless telephone of which handset is operated to remotely control the operation of a television receiver. The remote controlling of the television receiver is achieved by the use of infrared-rays.

Now the making of reservation for the picture recording on a video recorder by the use of code information such as the G-codes can simplify the operation for the picture recording, compared with the case of inputting data containing the recording date and time and so on in detail. However, in the case of using the code information such as the G-codes, the code information consisting of numerals and so on is formed so as to correspond to setting data for making reservation for the picture recording. Thus, the number of numerals and so on used for constituting the code information is apt to be increased, and an arrangement of these numerals and so on is not back grounded by any particular meaning. Therefore, even if there is any error in the input operation of the code information, it is difficult for the operator to immediately notice the mistakes made during the inputting. Consequently, there occurs such a problem that the picture recording on the video recorder is performed either on an erroneous date and time or with programs of an incorrect telecasting station.

Thus, another sort of product has been already developed, which is able to read code information such as the G-codes from the telecast list printed on a newspaper by the use of a bar code reader or an optical character reader so as to input via radio the read data to a video recorder by the use of radio signal such as infrared-ray signals. This sort of product can be excellent from the viewpoint of preventing failure of the picture recording due to an erroneous inputting of the code information.

Nevertheless, in the case of this sort of product, inputting of the code information to a video recorder cannot be achieved without existence of a paper medium on which the telecast list is printed as well as a special device for reading image information from the paper medium. If the accessory remocon of a video recorder is modified to a product having the function of reading the image information, the remocon must have an additional image reading function, and accordingly there occurs such a problem that the product becomes expensive and large in its physical size.

On the other hand, for instance, Japanese Publication of Unexamined Patent Applications No. 2000-197154 discloses a technique for remotely controlling electronic appliances in home by employing an information processing apparatus such as a portable telephone, which is capable of conducting mobile communication by radio. In this type of technique, controlling information necessary for setting of operation of electronic appliances including a television, a video tape recorder, an air conditioner and so on, is preliminarily held in an information processing apparatus. Thus, by using the GUI (graphical user interface), the contents of operation to be set on an electronic appliances that are the objects to be connected are determined, and thereafter a communicating connection to the home bus control terminal is completed for controlling these electronic appliances.

However, in the above technique, the controlling operation must be conducted only within the scope of the controlling information, which is preliminarily held in the information processing apparatus. That is to say, information that changes day by day, such as daily telecast programs and weather forecast, cannot be used for the controlling operation to make either reservation on a video tape recorder or operation prospect of an air conditioner. Therefore, as described before, the information changing day by day must be manually inputted by a human operator or be read by a machine.

### SUMMARY OF THE INVENTION

Therefore, an object of the present invention is provide an information processing apparatus capable of controlling diverse electronic appliances such as a video tape recorder by simple operation without necessity of existence of any paper medium such as telecasting lists and an electronic appliance controlling system for controlling external electronic appliances by the use of such information processing apparatus.

According to the invention as described in claim 1, an information processing apparatus is provided with:

(a) a controlling information receiving means for receiving controlling information for controlling a predetermined specified type of electronic appliance from a communication network;

(b) a data format converting means for converting the controlling information received by the controlling information receiving means to a data format capable of being read by a concretely specified electronic appliance as a controlled object; and

(c) a transmitting means for transmitting the controlling information after conversion by the data format converting means to a relevant electronic appliance.

In the invention as described in claim 1, the controlling information receiving means for receiving the controlling information for controlling the predetermined specified type of electronic appliance such as a video tape recorder from the communication network, is provided for the information processing apparatus such as a portable telephone and so on. Thus, the received controlling information is converted into a data format capable of being read by the electronic appliance so that the converted controlling information may be transmitted to the relevant electronic appliance. When the electronic appliance is, for example, a video tape recorder, controlling information concerning reservation for picture recording of a telecast program is received from the communication network, and is then converted into a data format applicable to an individual video tape recorder, so that the information after conversion may be transmitted to each concrete video tape recorder for enabling it to make reservation for the picture recording. As described above, since the information processing apparatus acquires necessary controlling information from the communication network so as to transmit it to the electronic appliance or appliances, it is possible to control the appliance such as a video tape recorder and so on by the simple operation without necessity of existence of any paper medium such as a telecast list or lists and without occurrence of any erroneous inputting of the information.

According to the invention as described in claim 2, the information processing apparatus is provided with:

(a) a controlling information receiving means for receiving a controlling information for controlling predetermined specified type of electronic appliances from a communication network;

(b) a controlling information selecting means for selecting necessary controlling information from the controlling information received by the controlling information receiving means;

(c) a data extracting means for extracting data, which are reading objects of a concretely specified electronic appliance that is a controlled object, from the data selected by the controlling information selecting means;

(d) a format converting means for converting the data extracted by the data extracting means to a signal format that the concretely specified electronic appliance can receive; and

(e) a transmitting means for transmitting the controlling information converted by the format converting means to the concretely specified electronic appliance.

Namely, in the invention of claim 2, the controlling information receiving means for receiving the controlling information for controlling the predetermined specified type electronic appliance such as a video tape recorder and so on from the communication network is provided for the information processing apparatus such as a portable telephone and so on. Then, the necessary controlling information is selected from the received controlling information by the controlling information selecting means. For instance, with a video tape recorder, the data showing e.g., a program list of the telecast are acquired from the communication network, and then actually necessary information is selected from the acquired data. This is different from the invention of claim 1 in which only controlling information actually corresponding to each appliance is acquired and controlling information actually necessary for the electronic appliance is selected. In the case of the invention of claim 2, the data extracting means is further provided for extracting data, which are objects to be read of the concretely specified electronic appliance as a controlled object, from the controlling information selected by the controlling information selecting means. With the example of a video tape recorder, the controlling information selecting means selects concrete programs to be recorded from the program lists of the telecast, and the data extracting means extracts data such as the G-code that is allowed to be received as recording reservation code by the video tape recorder. The data extracted by the data extracting means is converted by the format converting means into a signal format capable of being received by the concretely specified electronic appliance that a user desires to control. Since the signal format might change depending on respective manufacturers of video tape recorders, the data must be converted into a suitable signal format accordingly. Thus, the transmitting means transmits the controlling information after conversion by the format converting means to the specified appliance.

As described above, in accordance with the invention of claim 2, even if the controlling information transmitted by the communication network is rather general, the side of concrete electronic appliance is able to transmit only necessary controlling information to the appliance which is a controlled object. Further, since the information processing apparatus acquires only the necessary controlling information from the communication network in order to transmit it to the appliance, i.e., a controlled object, there is no necessity of any paper medium such as a telecast list, and as a user (an operator) on the side of the information processing apparatus operates so as to select the necessary information thereby producing suitable information, the controlling of the electronic appliance or appliances can be achieved by the simple operation without occurrence of any erroneous inputting of information.

In the case of the invention of claim 3, it is characterized that the information processing apparatus as described in claim 1 or 2 comprises a portable telephone and the transmitting means thereof comprises a communicating means using infrared-rays.

Namely, in the invention as described in claim 3, the portable telephone is provided as one preferable means suitable for extracting various information from information sources such as the Internet and so on and for transmitting them to other appliances. The portable telephone can be very excellent in that it has come into wide use and can easily access to a place neighboring an electronic appliance that is a controlled object. Further, the employment of the communicating means using the infrared-rays as the transmitting means permits the existing transmitting means of many types of conventional electronic appliances to be immediately used without necessity of any change. Of course, the information processing apparatus according to the present invention is not needed to acquire information from the information source by radio, and could be e.g., a game terminal connected to the communication network by wire. Furthermore, even if the information processing apparatus is one, which acquires information by radio, the present invention may be applicable to various kinds of information communicating appliances such as a mobile information appliance.

In the invention as described in claim 4, an electronic appliance controlling system is composed of (a) an information server for transmitting controlling information for controlling predetermined specified types of electronic appliances and (b) an information processing apparatus comprising; a controlling information receiving means for receiving the controlling information transmitted by the information server, a format converting means for converting the controlling information received by the controlling information receiving means into a signal format permitting a concretely specified electronic appliance to receive it, and a transmitting means for transmitting the controlling information converted by the format converting means to the concretely specified electronic appliance.

Namely, in the invention as described in claim 4, the information processing apparatus of the invention as described in claim 1 and the information server constitute the electronic appliance controlling system for controlling the electronic appliance.

In the invention as described in claim 5, the information server as described in claim 4 is characterized in that it transmits controlling information when the information processing apparatus requests acquirement of the controlling information.

Namely, with the invention as described in claim 5, only the controlling information necessary for the side of a user can be acquired, and accordingly for example, in a system by which fare is charged on the transmission of controlling information, it is possible to prevent any unnecessary fare from being charged.

In accordance with the invention as described in claim 6, the information server as described in claim 4 is characterized in that it automatically distributes controlling information to a specified electronic appliance regardless of the request of the appliance.

Namely, the invention as described in claim 6 is different from the invention as described in claim 5 in that the information server automatically and autonomously distributes the necessary information to the electronic appliance. Therefore, for example, information concerning the maintenance therefor can be supplied to the side of the electronic appliances without missing it. Of course, the automatic and autonomous distribution of information may be supplied on business to only specified contractors.

The above and other objects, features, and advantages of the present invention will become more apparent from the following description based on the accompanying drawings which illustrate an example of a preferred embodiment of the present invention.

### BRIEF DESCRIPTION OF THE DRAWINGS

FIG. 1 is a schematic block diagram illustrating the construction of an electronic appliance controlling system using a portable telephone according to an embodiment of the present invention;

FIG. 2 is a block diagram illustrating the construction of the portable telephone of the present embodiment;

FIG. 3 is a flow chart illustrating the presetting process of an electronic appliance during the presetting mode, according to the present embodiment;

FIG. 4 is flow chart illustrating the process for making reservation of picture recording on a video tape recorder, according to the present embodiment;

FIG. 5 is a flow chart illustrating an principal portion of the controlling operation carried out on the side of a portable telephone of an electronic appliance controlling system according to a first modification of the present invention;

FIG. 6 is a flow chart illustrating the process of controlling on the side of the video tape recorder according to the first modification;

FIG. 7 is a flow chart illustrating an principal portion of the controlling operation taken place on the side of a portable telephone of an electronic appliance controlling system according to a second modification of the present invention; and,

FIG. 8 is a flow chart illustrating approximately the controlling operation carried out on the side of an air conditioner, according to the second modification.

### DETAILED DESCRIPTION OF THE PREFERRED EMBODIMENTS

The detailed description of the preferred embodiment of the present invention and its modifications will be provided hereinafter.

(The Embodiment)

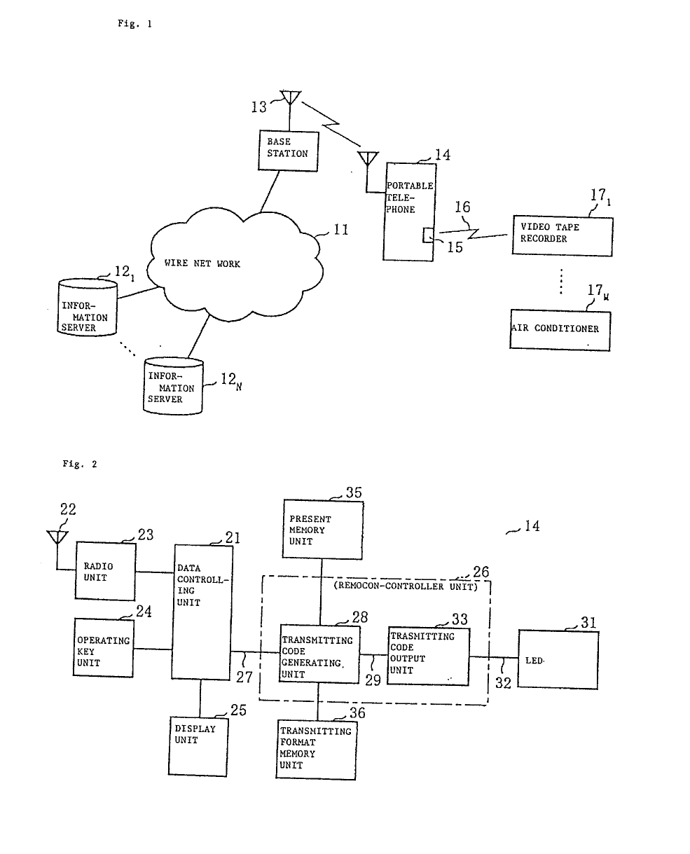

FIG. 1 illustrates an abstract of the construction of an electronic appliance controlling system using a portable telephone as an information processing apparatus, according to an embodiment of the present invention.

Referring to FIG. 1, there is shown wire network 11 represented by the Internet and a portable telephone network, to which information servers 12₁ through 12_{N} and base station 13 which provide various kinds of information such as telecast programs are connected. Base station 13 is arranged to do a radio communication with portable telephone 14. Portable telephone 14 is provided therein with infrared-ray transmitting circuit 15 so as to conduct controlling of electronic appliances 17₁ through 17_{M} such as a video tape recorder and so on by the use of infrared-ray 16.

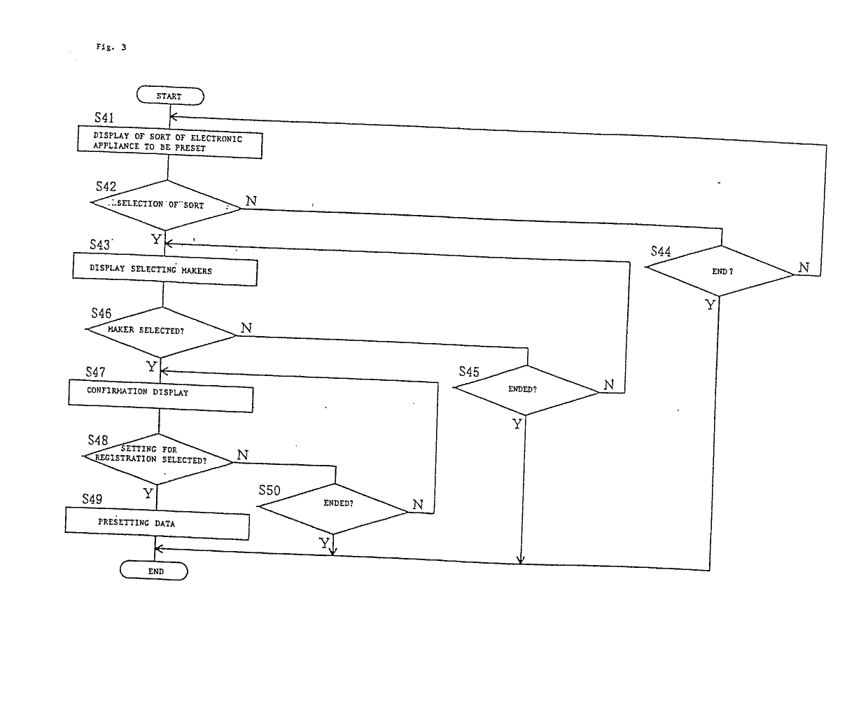

FIG. 2 illustrates the construction of portable telephone 14 of FIG. 1. Portable telephone 14 is provided with data-controlling unit 21 constituted by a non-illustrated CPU (Central Processing Unit), a ROM (Read Only Memory) for storing therein controlling programs, a RAM (Random Access Memory) used as an operating memory, and so on. Data-controlling unit 21 is arranged to be connected to radio unit 23 having antenna 22 attached thereto, operating key unit 24 in which operating keys are arranged, display unit 25 consisting of a liquid crystal display and its drive circuit (both are not shown), and remocon-controller unit 26 for remotely controlling electronic appliances 17₁ through 17_{M} shown in FIG. 1.

Remocon-controller unit 26 is provided with transmitting-code generating unit 28 supplied with controller data 27 from data-controlling unit 24, and transmitting-code output unit 33 to which transmitting-code 29 is inputted from transmitting-code generating unit 28 so as to output drive signal 32 for driving infrared light emitting diode (LED) 31. Transmitting-code generating unit 28 is arranged so that two memory units, i.e., preset memory unit 35 and transmitting format memory unit 36, are connected to unit 28. Transmitting format memory unit 36 stores therein the respective formats of transmitting-code for remotely and separately controlling electronic appliances 17₁ through 17_{M} such as a video tape recorder and so on. Preset memory unit 35 stores therein preset information comprised of manufacturers' name, product numbers and so on with respect to electronic appliances 17₁ through 17_{M} for using it to specify each individual format.

At this stage, data-controlling unit 21 conducts entire controlling for permitting controller unit 26 to operate in association with radio unit 23 and the other units connected to unit 21, and further controls the transmitting and receiving of the data implemented in radio unit 23, the processing of input data at the time when an operator conducts various operation from operating key unit 24, and the displaying by displaying unit 25 in a manner similar to that of the controlling performed by the conventional portable telephone. However, the explanatory description of the latter controlling operation will be omitted here in principle, and the description of the remote controlling operation for the electronic appliances will centrally be provided hereinbelow.

The operator operates portable telephone 14 shown in FIG. 2 to select from a non-illustrated display of portable telephone 14, a preset mode of an electronic appliance. The preset mode should be understood as one of modes, which specifies an electronic appliance that is an object to be controlled by portable telephone 14. For example, when a plurality of electronic appliances within a home should be controlled by portable telephone 14, it is possible to conduct presetting for each individual appliance of them. Here, the case where presetting of the video tape recorder 17₁ is performed under the preset mode.

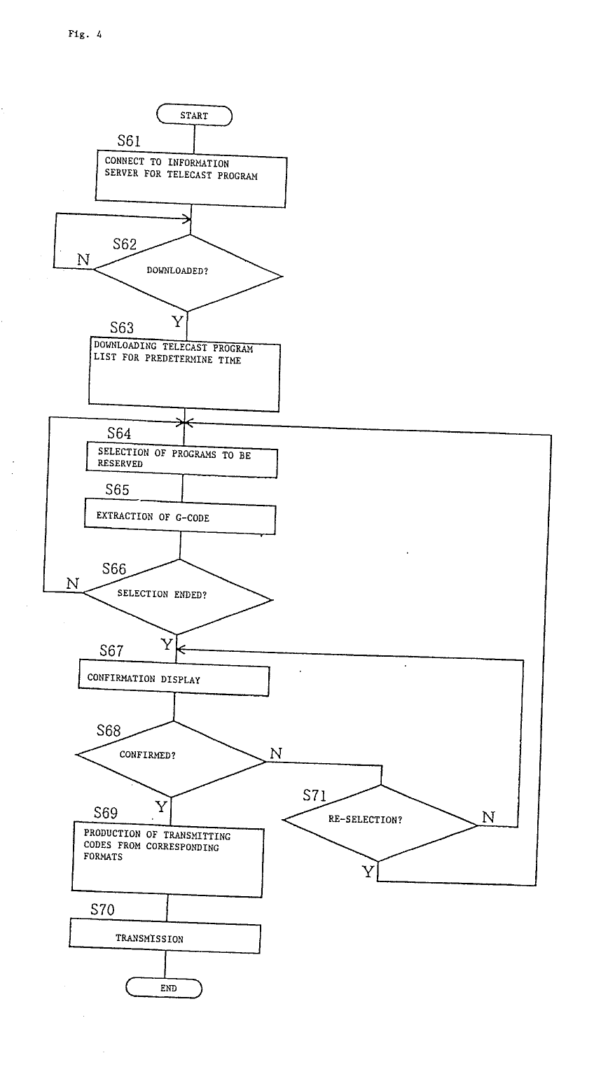

FIG. 3 illustrates the flow of processing when the presetting of an electronic appliance is performed under the preset mode. Under the preset mode, data-controlling unit 21 reads out the data concerning the sort or type of the electronic appliance from the aforementioned ROM thereby permitting display unit 25 to display the data (step S41). Then, the operator operates operating key unit 24 to input the sort of the appliance to be preset. Thus, when video tape recorder 17₁ is selected as the sort of the appliance (step S42: Y), data-controlling unit 21 then reads out a list of manufactures corresponding to the selected electronic appliance thereby permitting display unit 25 to display thereon the selecting picture (step S43).

It should be noted that when the screen for selecting the sort of the electronic appliance is displayed at step S41, the operator could complete the preset mode of the electronic appliance without practicing the mode (step S42: N, step S44: Y). In this case, the processing goes to an end (End) to return to the main menu again.

On the other hand, when the selected picture of the manufactures is displayed at step S43, the operator selects the name of the manufacturer of the video tape recorder 17₁ in this example. When the operation to complete the preset mode is not performed (step S46: N, step S45: N), and when the inputting of the selection of the manufacturer is performed (step S46: Y), data-controlling unit 21 permits display unit 25 to display a confirmation picture (step S47). Namely, for example, the confirmation picture stating “the video tape recorder made by the company A is set for registeration” is displayed. In this respect, when the operator selects the setting for registration (step S48:Y), the data specifying the video tape recorder made by the company A is set in preset memory unit 35 (step S49). If the operator selects the completion of the mode without selecting the setting for registration (step S48: N, step S50: Y), the preset mode is completed in a manner as described hereinbefore (End), and the processing is returned to the main menu again.

When the operator conducts continuous presetting of a plurality of electronic appliances such as, for example, not only house hold video tape recorder 17₁ but also an air conditioner, a television and so on, the above-described processing is repeated a plurality of times. Thus, the data for specifying one or a plurality of electronic appliances, which can be controlled by specified portable telephone 14 are stored in preset memory unit 35.

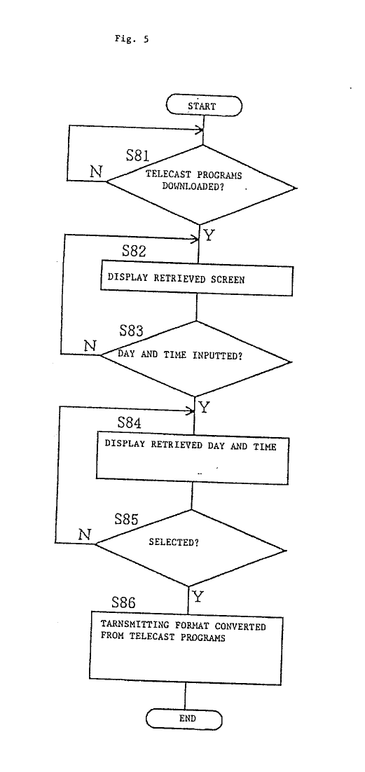

FIG. 4 illustrates the flow of processing for making reservation for the picture recording on a video tape recorder. The operator operates portable telephone 14 to connect it to an information server arranged exclusively for the provision of television programs (hereafter called as telecast programs) (step S61). In the present embodiment, it is assumed that this information server corresponds to information server 12₁ shown in FIG. 1. When portable telephone 14 is connected to information server 12₁, data is sent from information server 12₁ for inquiring whether or not downloading of the data concerning the list of the telecast program should be conducted (step S62). When the operator operates operating key unit 24 (refer to FIG. 2) in order to reply that the downloading should be conducted, data-controlling unit 21 of portable telephone 14 detects the reply and sends the request for the downloading to information server 12₁ (step 62: Y). Based on this request, information server 12₁ transmits the data concerning the list of the telecast programs of predetermined broadcasting stations for a predetermined time period (step S63).

It should be noted that there is either a case where the side of portable telephone 14 firstly accesses information server 12₁, or a case where a change of the combination of the telecast programs and the broadcasting stations is made. In these cases, the setting of permission of the downloading as shown simply in step S62 should be replaced with the displaying of a non-illustrated setting screen for the downloading of the telecast programs, so that setting or changing of the content may be conducted therethrough. Thus, the content once set is memorized in information server 12₁ in the form corresponding to the telephone number of the portable telephone, and therefore a more command for the permission of downloading makes it possible to download the data concerning the necessary telecast programs to portable telephone 14.

When the data concerning the telecast programs are downloaded to portable telephone 14, the operator is able to select telecast programs to be reserved from the content of the list of the telecast programs displayed on display unit 25 of portable telephone 14 (step S64). Whenever one of the telecast programs is selected, data-controlling unit 21 extracts a G-code, and indicates a cursor at the place of the G-code (step S65). The extraction of the G-code is conducted by retrieving the code information of the number of digits of the numerals that constitute the G-code, from the head of the data of the selected telecast programs. Until the operator indicates completion of the selecting operation, selection of a plurality of telecast programs may be effected (step S66).

When the selection of the telecast programs is completed (step S66: Y), data-controlling unit 21 shown in FIG. 2 allows display unit 25 of portable telephone 14 to display the list of the selected telecast programs and respective time zones (step S67). Thus, the operator conducts checking of the displayed content, and when the operator conducts an operation for “confirmation” (step S68: Y), transmitting-code generating unit 28 reads out the data concerning the sort of the electronic appliances and the manufacturers thereof, which are stored in preset memory unit 35, and further reads out the corresponding formats stored in transmitting format memory unit 36 to produce the transmitting codes (step S69). Then, the produced transmitting codes are transmitted to video tape recorder 17₁ by using infrared transmitting circuit 15 via infrared-rays (step S70). Thus, the reservation of the desired telecast programs is completed.

At this stage, when the operation for the “confirmation” of step S68 is not conducted, and when the operator conducts an operation for re-selecting the telecast programs (step S71: Y), the processing is returned to step S64 to conduct the re-selection of the telecast programs.

Further, in the present embodiment, the screen for confirmation of the reservation of the telecast programs is displayed at step S67. However, this display of the confirmation screen may be omitted, and instead when all of the telecast programs are selected together at the step S66, all of the G-codes of these programs may be transmitted together after conversion of all G-codes into a transmitting format. In this case, the processing of step S65 is unnecessary. Of course, instead of processing all together, the conversion of the G-code may be conducted every time a telecast program is selected, and in such case, transmission of the transmitting code might be effected each time.

(The First Modification)

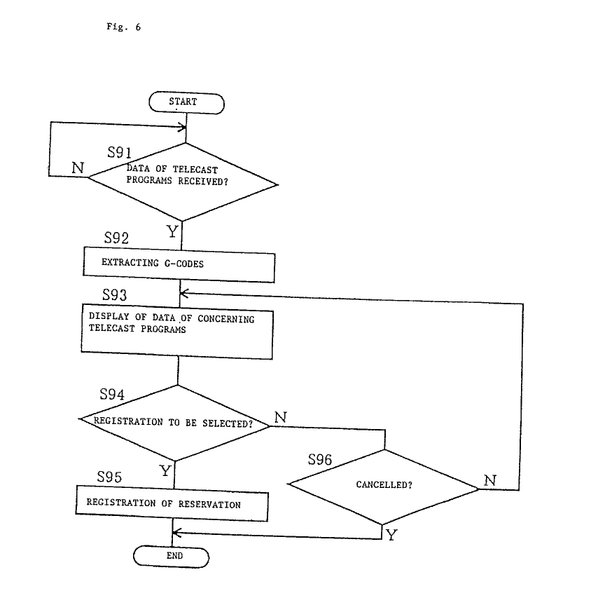

FIG. 5 illustrates an principal portion of the control on the portable telephone side in the electronic appliance controlling system according to a first modification of the above-described embodiment.

When a telecast program or telecast programs are downloaded from information server 12₁ of FIG. 1 (step S81: Y), portable telephone 14 displays on its display unit 25 a retrieval screen (step S82). Under this condition, the operator inputs, from the data of the telecast programs, relevant dates and times or only relevant times if the date is the same as that date of input, by using operating key unit 24 (FIG. 2). Thus, when the inputting of the time information for the retrieval is completed (step S83: Y), data-controlling unit 21 retrieves the telecast programs on the relevant dates and times to display the result of retrieval on display unit 25 (step 84).

The operator looks at the displayed content, and selects some of the telecast programs for picture reservation. Thus, when the selection of the telecast programs for the picture reservation are completed (step S85: Y), data-controlling unit 21 commands the controller unit 26 so that the telecast programs are converted into the corresponding transmitting formats in a manner as described in the previous embodiment, to thereby produce the data of the telecast programs. Then, the data are transmitted from infrared-ray transmitting circuit 15 within radio unit 23 (step S86).

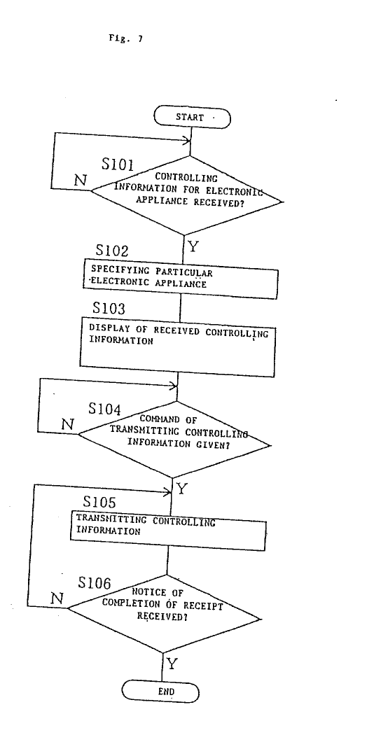

FIG. 6 illustrates the flow of the controlling process made on the video tape recorder side in this modification. Video tape recorder 17₁ of the previous embodiment is a widely used video tape recorder, and therefore upon receipt of the G-codes, the recorder immediately uses them to make reservation for the picture recording. Nevertheless, it should be understood that video tape recorder 17₁ of the first modification is provided with a function for extracting G-codes out of the received data. This is because portable telephone 14 of this modification transmits all of the data of the relevant telecast programs together to the video tape recorder without extraction of any G-code.

On the side of the video tape recorder 17₁, when the data of the telecast programs are received (step S91: Y), as described in the previous embodiment, the data constituted by the predetermined number of numerals or characters are extracted as G-codes (step S92). Based upon these G-codes, the data concerning the channel numbers and recording times of the corresponding telecast programs are displayed on a non-illustrated display (step S93). Then, from the displayed content, the operator can select one of the two operations, i.e., “registration” and “cancellation” by using a non-illustrated operating unit on the side of video tape recorder 17₁. When the operator selects the operation of “registration” (step S94: Y), the registration of reservation for the telecast programs is completed (step S95). On the contrary, when the operator selects the operation “cancellation” (step S94: N, step S96: Y), the processing on the side of video tape recorder 17₁ is completed without making any reservation of the telecast programs (End).

In this first modification, in consideration of the case of erroneous extraction of the G-codes, the process of confirmation of the extracted G-codes is conducted at steps S93, S94, and S96. However, as required, it might be possible to conduct registration of the reservation for the telecast programs while omitting of such confirmation process (step S95). Further, in this modification, although the extraction of the G-codes is conducted by the side of video tape recorder 17₁ so as to reduce any extra load of extraction of the G-codes provided on portable telephone 14, it is, of course, possible to adopt such a processing that the extraction of the G-codes is conducted on the side of portable telephone 14. In such case, the particular controlling process of video tape recorder 17₁ as shown in FIG. 6 is not required. Further, in this first modification, the data concerning the time or hour are inputted in order to select the telecast programs. However, either other retrieving data might be inputted to do manual retrieval or a plurality of retrieving conditions might be set for the retrieval.

(The Second Modification)

In the electronic appliance controlling system of the next second modification, information servers 12₁ through 12_{N} as shown in FIG. 1 appropriately transmit, to respective portable telephones 14 under a predetermined contract, the controlling information necessary for the electronic appliances owned by the users of portable telephones 14 (the operators). In this modification, Nth information server 12_{N} is assumed to be a service company providing a service relative to the weather forecast, and the description of an example in which the controlling information for the air conditioner 17_{M} that is one of the electronic appliances is periodically supplied to the portable telephone 14 will be provided hereinbelow.

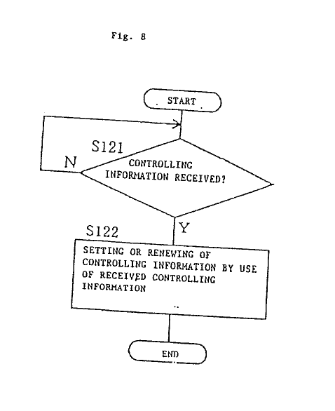

FIG. 7 illustrates the flow of an principal portion of the controlling process made on the side of a portable telephone in the electronic appliance controlling system according to the second modification. When portable telephone 14 receives a controlling information for the electronic appliances (step S101: Y), it determines electronic appliances that are to be controlled from the information specifying the sort of information server 12 and further information attached to the electronic appliance controlling information to specify particular electronic appliances (step S102). In this modification, the controlling information relative to the weather forecast which is a premise of air conditioner 17_{M} to be controlled is received from Nth information server 12_{N}.

Data-controlling unit 21 shown in FIG. 2 stores the controlling information in a non-illustrated built-in memory, and determines the electronic appliance that is an object of controlling (air conditioner 17_{M} in this case) while displaying on display unit 25 the fact that the controlling information was received (step S103). Thus, when the operator recognizes the displaying on display unit 25, a command may be immediately given by the operator to portable telephone 14 to transmit the controlling information to air conditioner 17_{M}, if the latter is located at a position adjacent to the operator (step S104). However, the operator might often be out of the house and away from air conditioner 17_{M} to be controlled. Therefore, as soon as portable telephone 14 receives the command for transmitting the controlling information from the operator (step S104: Y), telephone 14 transmits the controlling information to air conditioner 17_{M} (step S105). Then, when a notice of completion of receipt of the controlling information from air conditioner 17_{M} arrives (step S106: Y), portable telephone 14 completes the processing of the transmission of the controlling information (End).

FIG. 8 schematically illustrates the flow of the controlling process conducted on the side of the air conditioner according to the second modification. The air conditioner 17_{M} is waiting for receiving of the controlling information (step S121), and as soon as it receives the controlling information (step S121: Y), the content of the controlling for air conditioner 17_{M} is either set or renewed by the use of the received controlling information (step S122). Namely, in compliance with a change in the outdoors weather due to time lapse, which is shown by the information on the weather forecast, the temperature and humidity in a given room are changed from the standard controlling content. Thus, on a day when the outdoors temperature is extremely low, it is possible either to slightly lower the temperature in the room from the standard temperature value or to adjust the temperature and humidity in the room thereby permitting a human body to be easily adapted to the environmental temperature around the turn of the weather.

In the described second modification, there has been provided a description of a case where the controlling information on the weather forecast is used for controlling the air conditioner 17_{M}. However, it should be understood that the second modification is not intended to be limited to such case, and alike the previous embodiment and the first modification, the present modification will be applicable to the transmitting and receiving of various kinds of controlling information in relation to various kinds of electronic appliances. Further, in the present modification, a case is described in which the controlling information is periodically supplied from the information servers. However, alternately, it should be noted that the supply of any controlling information may be conducted at the time of occurrence of any important controlling information, for example, when any change in the controlling information has occurred or a correction of a product should be made.

Furthermore, in the described embodiment and the modifications, examples have been illustrated in which information servers 12₁ through 12_{N} are connected to wire network 11. However, wire network 11 might be replaced with either a portable telephone network for portable telephones 14 or the Internet connected to the portable telephone network. Also, the present invention may be similarly applicable to a communication network, which employs, in a part thereof, a cable television network (CATV).

As described in the foregoing, in accordance with the invention as claimed in claims 1 through 6, since the information processing apparatus transmits controlling information received by a controlling information receiving means from a communication network after converting the information into data formats that can be read by predetermined specified electronic appliances, to the relevant electronic appliances, the transmission of the information is consistently conducted by the electric signals. Thus, the electronic appliances such as video tape recorders and so on can be controlled by a simple operation without necessity of any paper medium such as a telecast list, and without occurrence of any erroneous inputting of the information.

Further, in accordance with the invention as claimed in claim 2, only necessary controlling information can be selected by the controlling information selecting means from the controlling information received by the controlling information receiving means, and from such controlling information selected by the controlling information selecting means, the data that can be objects readable to the concretely specified electronic appliances are extracted by the data extracting means. Then, the data extracted by the data extracting means are converted to signal formats readable to the concretely specified electronic appliances and are subsequently transmitted to the relevant electronic appliances. Therefore, a user (an operator) on the side of the information processing apparatus can selectively take in or discard the controlling information at his or her own will. Furthermore, the information source arranged on the side of the communication network is sufficient to transmit only the generalized controlling information, and accordingly any cost incurred by the use of the information can be reduced.

In accordance with the invention as claimed in claim 3, since the widely used portable telephones are employed, the operation of the controlling system can be achieved by a large majority of persons without necessity of additional purchase of particular devices. Also, since the portable telephone may be easily moved to the site where the electronic appliances that are controlled objects are arranged, such advantage can be acquired that any limit to an extent of the electronic appliances that can be controlled objects is not reduced. Furthermore, in the present invention, since the transmitting means is constituted by a communication means employing the infrared-rays, it is possible to immediately use the existing communicating means of many of the electronic appliances.

Further, in accordance with the invention as claimed in claim 5, the information server transmits controlling information in response to a request for acquirement of the controlling information from the information processing apparatus, and therefore, for example, in a system in which fare is charged to the transmission of the controlling information, it is possible to prevent occurrence of any inappropriate situation in which undue fare is charged.

Furthermore, in accordance with the invention described in claim 6, since the side of the information server automatically and independently supplies necessary information to the electronic appliances, it is possible to unfailingly by supply the side of the electronic appliances with maintenance information necessary for the appliances and so on.

Although certain preferred embodiments of the present invention have been shown and described in detail, it should be understood that various changes and modification may be made therein without departing from the scope of the appended claims.

What is claimed is:

1. An information processing apparatus comprising:
a controlling information receiving means for receiving controlling information for controlling a predetermined specified type of electronic appliance from a communication network;
a data format converting means for converting the controlling information received by the controlling information receiving means into a data format capable of being read by a concretely specified electronic appliance as a controlled object; and
a transmitting means for transmitting the controlling information after conversion by the data format converting means to a relevant electronic appliance.

2. An information processing apparatus comprising:
a controlling information receiving means for receiving controlling information for controlling a predetermined specified type of electronic appliance from a communication network;
a controlling information selecting means for selecting necessary controlling information from the controlling information received by the controlling information receiving means;
a data extracting means for extracting data to be read by a concretely specified electronic appliance that is a controlled object, from the data controlling information selected by the controlling information selecting means;
a format converting means for converting the data extracted by the data extracting means into a signal format capable of being eceived by said concretely specified electronic appliance; and
a transmitting means for transmitting the controlling information converted by the format converting means to said concretely specified electronic appliance.

3. The information processing apparatus according to claim 1, wherein said information processing means comprises a portable telephone, and wherein said transmitting means comprises a communicating means employing infrared-rays.

4. The information processing apparatus according to claim 2, wherein said information processing means comprises a portable telephone, and wherein said transmitting means comprises a communicating means employing infrared-rays.

5. An electronic appliance controlling system comprising:
an information server for transmitting controlling information for controlling a predetermined specified type of electronic appliance; and
an information processing apparatus provided with: a controlling information receiving means for receiving said controlling information transmitted by the information server; a format converting means for converting the controlling information received by the controlling information receiving means into a signal format capable of being received by a concretely specified electronic appliance; a transmitting means for transmitting the controlling information converted by the format converting means to said concretely specified electronic appliance.

6. The electronic appliance controlling system according to claim 5, wherein said information server transmits said controlling information upon request for acquirement of said controlling information from the information processing apparatus.

7. The electronic appliance controlling system according to claim 5, wherein said information server automatically supplies to a specified information processing apparatus with said controlling information irrespective of a request from said apparatus.
